(19) United States
(12) Patent Application Publication
(10) Pub. No.: US 2011/0029936 A1
(43) Pub. Date: Feb. 3, 2011

(54) Method of generating layout of semiconductor device

(75) Inventors: Kyoung-yun Baek, Suwon-si (KR); Seong-woon Choi, Suwon-si (KR); Suk-joo Lee, Yongin-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/662,411

(22) Filed: Apr. 15, 2010

(30) Foreign Application Priority Data
Jul. 30, 2009 (KR) 10-2009-0069963

(51) Int. Cl. G06F 17/50

(52) U.S. Cl. 716/50

(57) ABSTRACT

A method of manufacturing a semiconductor device, and more particularly, a method of generating a layout of a semiconductor device. The method of preparing layout of a semiconductor device may include preparing a design layout including a main pattern; dividing the design layout into a plurality of first pieces of layout; preparing a plurality of second pieces of layout by providing a dummy pattern on each of the plurality of first pieces of layout; preparing a plurality of third pieces of layout by performing an optical proximity correction (OPC) process with respect to each of the plurality of second pieces of layout; and recombining the plurality of third pieces of layout.

### CROSS-REFERENCE TO RELATED APPLICATIONS

This application claims priority under 35 U.S.C. §119 to Korean Patent Application No. 10-2009-0069963, filed on Jul. 30, 2009, in the Korean Intellectual Property Office (KIPO), the entire contents of which are incorporated herein by reference.

### BACKGROUND

1. Field

Example inventive concepts relate to a method of manufacturing a semiconductor device, and more particularly, to a method of generating a layout of a semiconductor device and a computer readable recording medium including a program for executing the method of generating the layout of the semiconductor device.

2. Description of the Related Art

As design rules of semiconductor devices are becoming smaller, the degree of process difficulty may be getting higher. However, the development of light exposure equipment that may realize the design rules has reached a limit. One technology for overcoming such limitations may be optical proximity correction (OPC). As capacity and density of a semiconductor device increase, time for performing an OPC process may increase. Accordingly, manufacturing costs of a semiconductor device increase.

### SUMMARY

Example inventive concepts provide a method of generating a layout of a semiconductor device, which effectively reduces the time required for performing an optical proximity correction (OPC) process. Example inventive concepts also provide a computer readable recording medium including a program for executing the method of generating the layout of the semiconductor device. Additional aspects will be set forth in part in the description which follows and, in part, will be apparent from the description, or may be learned by practice of example embodiments.

According to example embodiments of inventive concepts, a method of generating a layout of a semiconductor device may include preparing a design layout including a main pattern; dividing the design layout into a plurality of first pieces of layout; preparing a plurality of second pieces of layout by providing a dummy pattern on each of the plurality of first pieces of layout; preparing a plurality of third pieces of layout by performing an optical proximity correction (OPC) process with respect to each of the plurality of second pieces of layout; and recombining the plurality of third pieces of layout.

According to example embodiments of inventive concepts, a computer readable recording medium may include a program for executing the method of generating the layout of the semiconductor device as described above.

The dummy pattern may be generated around a main pattern so as to uniformly maintain a space and density around the main pattern. A configuration and location of the main pattern may be in accordance with a hierarchy structure of the design layout, and the plurality of first pieces of layout may be in accordance with the hierarchy structure of the design layout. The dummy pattern may not be in accordance with the hierarchy structure of the design layout.

In preparing the plurality of third pieces of layout, the OPC process may be performed simultaneously on the main pattern and the dummy pattern. Preparing the plurality of third pieces of layout may further include performing the same OPC process only once for each piece of the plurality of second pieces of layout that have the same shape. The dummy pattern may be provided on a boundary of the plurality of first pieces of layout.

Preparing the plurality of third pieces of layout may further include forming a modified main pattern and a changed dummy pattern by performing the OPC process simultaneously on the main pattern and the dummy pattern. The plurality of second pieces of layout and the plurality of third pieces of layout may be prepared simultaneously. The plurality of second pieces of layout may be prepared before the plurality of third pieces of layout.

### BRIEF DESCRIPTION OF THE DRAWINGS

Example embodiments of inventive concepts will be more clearly understood from the following detailed description taken in conjunction with the accompanying drawings. FIGS. 1-3E represent non-limiting, example embodiments as described herein.

FIG. 1 is a flowchart illustrating a method of generating a layout of a semiconductor device, according to example embodiments of inventive concepts;

FIGS. 2A through 2E are diagrams sequentially illustrating the method, according to example embodiments of inventive concepts; and

FIGS. 3A through 3E are diagrams sequentially illustrating a method of generating a layout of a semiconductor device, according to a comparative embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

Hereinafter, example embodiments will be described in detail with reference to the attached drawings. Example embodiments may, however, be embodied in many different forms and should not be construed as being limited to those set forth herein; rather, these example embodiments are provided so that this disclosure will be thorough and complete, and will fully convey inventive concepts to those skilled in the art. In the drawings, the sizes and thicknesses of layers and regions are exaggerated for clarity. It will be understood that when an element, such as a layer, a region, or a substrate, is referred to as being “on” or “connected to” another element, the element may be directly “on” or “connected to” the other element, or intervening element may be present. Alternatively, when the element is “directly on” or “directly connected to” the other element, it will be understood that intervening elements are not present. In the drawings, like reference numerals denote like elements. The term “and/or” includes any one of at least one of listed items.

The terms, such as first, second, and the like, are used to describe various elements, components, areas, layers, and/or parts, but it is obvious to one of ordinary skill in the art that the elements, components, areas, layers, and/or parts are not limited by these terms. These terms are used only to distinguish one element, component, area, layer, or part from another. Accordingly, a first element, component, area, layer, or part may denote a second element, component, area, layer or part, without deviating from the teachings of example embodiments of inventive concepts.

The relative terms, such as “top” or “above” and “bottom” or “below”, may be used describe a relationship of an element with another element, as illustrated in drawings. The relative terms intend to include other directions of a device, in addition to a direction described in the drawings. For example, when a semiconductor package may be turned over in the drawings, elements that are described to exist on a surface of other elements are now disposed below the other elements. Accordingly, the relative term, for example, “above”, may include both “below” and “above” depending on a direction of the drawings. When a device faces another direction (90° rotation with respect to a direction, the relative terms may be interpreted accordingly.

The terms used in the present specification are used to describe example embodiments of inventive concepts, and not to limit the inventive concepts. A singular form may include a plural form, unless otherwise defined. The term “comprise” and/or “comprising” specify the existence of mentioned shapes, numbers, steps, operations, elements, parts, and/or groups thereof, and do not exclude existence or addition of at least one other shapes, numbers, steps, operations, elements, parts, and/or groups thereof.

Optical proximity correction (OPC) will be described. A photo mask used in photolithography may include circuit patterns corresponding to each layer of a semiconductor device. The circuit patterns may be projected on a target region, e.g., a substrate, coated with a photosensitive material layer, e.g., a photo resist layer. Via a stepper device, each circuit pattern may be projected on an entire wafer, in a step-by-step method. A scanner, as a step-and-scan apparatus, may be alternatively used for the projection. In a photolithography process, an image of a pattern of a photo mask may be projected on a substrate, e.g., a silicon wafer, having some portion that may be coated with a resist layer to form a patterned layer.

Before imaging, the substrate goes through several pre-processes, e.g., resist coating and soft baking, and after such an imaging step, the substrate goes through several post-processes, e.g., post exposure baking (PEB), developing, hard baking, and measuring/testing. The patterned layer goes through various processes, e.g., etching, ion injection (doping), metalizing, oxidation, and chemical-mechanical polishing. Such a photolithography operation may be performed on each of a plurality of layers, and as a result, a semiconductor device may be formed on the substrate. The substrate on which the semiconductor device is fabricated may be divided, and the divided portions may be used as a semiconductor apparatus via a packaging process.

A photo mask may include geometrical patterns corresponding to circuit elements to be integrated on a silicon wafer. In order to generate the geometrical patterns for the photo mask, a computer-aided design (CAD) program may be used. For example, the geometrical patterns for the photo mask may be generated via electronic design automation (EDA).

A certain uniform rule may be applied for generating the pattern for the photo mask. A CAD program usually includes a set of predetermined or given design rules for generating the pattern. For example, design rules may define an interval tolerance between circuit devices, e.g., gates or capacitors, or mutually connected lines, so that the circuit devices or mutually connected lines do not mutually react with each other in an undesired manner. A design rule limitation may be generally referred to as a critical dimension (CD). In other words, the CD of a circuit may be the minimum width of a line or a hole, or the minimum distance between two lines or two holes. Accordingly, the CD determines the overall size and density of the circuit. As the size of a semiconductor device circuit decreases and density thereof increases, the CD of a pattern becomes close to a limit in resolution that a light exposure tool may achieve. The resolution of the light exposure tool may be defined by a minimum pitch that can be repeatedly exposed on a wafer.

As semiconductor devices become more highly integrated, the dimensions of a circuit may decrease. A ratio of a light exposure wavelength to a numerical aperture (NA) of an imaging system may be reduced for image fidelity. In order to improve performance of a semiconductor device, the minimum pitch in chip designs needs to be reduced, and thus, light exposure tools using shorter wavelengths and a higher NA are being developed. In order to overcome limitations of current photolithography light exposure tools, mask data modification by OPC may be used to advance photolithography.

OPC not only compensates for optical proximity, but also compensates for a proximity effect that may occur during a non-optical process, e.g., an etching or chemical-mechanical planarization (CMP) process. In example embodiments of inventive concepts, problems that occur while generating a dummy pattern that compensates for a loading effect of an etching process or while performing an OPC process on the dummy pattern may be solved. A dummy pattern that compensates for etch loading may be called an etch-dummy pattern. The etch-dummy pattern may be generated around a main pattern so as to uniformly maintain a space and density around the main pattern, thereby minimizing or reducing a loading effect that may be generated during a plasma etch process. A conventional dummy pattern is a pattern that may be inserted as a dummy, and enough of the pattern may be generated to not generate a problem in terms of patterning. However, a dummy pattern having a design similar to a main pattern is being used, instead of a dummy pattern having a bulk shape. Accordingly, a dummy pattern needs to be patterned by performing an OPC process, e.g., a main pattern may be patterned.

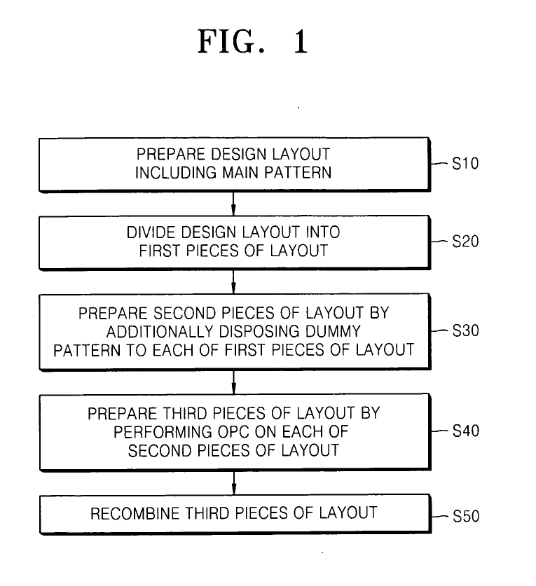

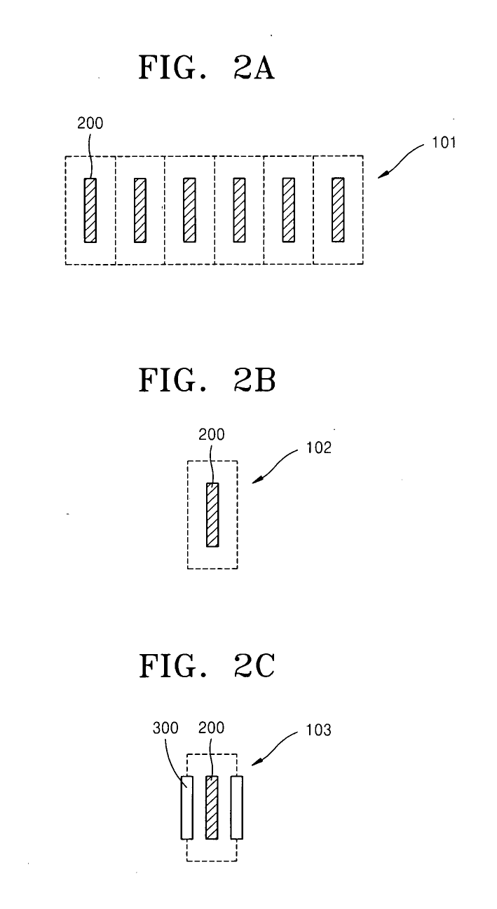

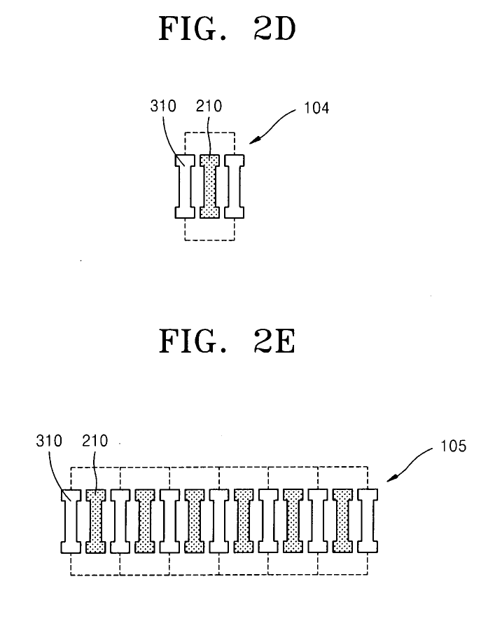

FIG. 1 is a flowchart illustrating a method of generating a layout for patterns of a semiconductor device, according to example embodiments of inventive concepts, and FIGS. 2A through 2E are diagrams sequentially illustrating the method, according to example embodiments of inventive concepts. Referring to FIGS. 1 and 2A through 2E, a design layout 101 including a main pattern 200 may be prepared in operation S10. Referring to FIG. 2A, the main pattern 200 may include a plurality of unit patterns having the same configuration arranged at uniform intervals. Configuration and location of the main pattern 200 may be in accordance with a hierarchy structure of the design layout 101. The design layout 101 may be divided into a plurality of first pieces of layout 102 in operation S20. The plurality of first pieces of layout 102 may be the unit pattern of the main pattern 200 as shown in FIG. 2B. Accordingly, the plurality of first pieces of layout 102 may be in accordance with the hierarchy structure of the design layout 101.

A dummy pattern 300 may be disposed on each of the plurality of first pieces of layout 102, thereby preparing a plurality of second pieces of layout 103 in operation S30. The dummy pattern 300 may compensate for proximity effects that are generated during a non-optical process. For example, the dummy pattern 300 may be an etch-dummy pattern that is disposed to compensate for an etch-loading effect while forming the main pattern 200 via a following etch process. Because the dummy pattern 300 compensates for the proximity effects that are generated during the non-optical process, the dummy pattern 300 may not be formed having the same configuration and location as those of the main pattern 200 in accordance with the hierarchy structure of the design layout 101. The dummy pattern 300 may be disposed on a boundary of the plurality of first pieces of layout 102 as shown in FIG. 2C. However, the location of the dummy pattern 300 may not be limited thereto, and may be disposed within the boundary of the plurality of first pieces of layout 102.

In operation S40, a plurality of third pieces of layout 104 may be prepared by performing an OPC process on each of the plurality of second pieces of layout 103. In operation S40, a modified main pattern 210 and a changed dummy pattern 310 may be realized by performing the OPC process simultaneously on the main pattern 200 and the dummy pattern 300. Accordingly, the plurality of third pieces of layout 104 may include the modified main pattern 210 and the changed dummy pattern 310. In operation S40, the same OPC may not be performed repeatedly for each of the plurality of second pieces of layout 103 that have the same shape. In other words, the same OPC process may not be repeatedly performed for each piece of the second pieces of layout 103 that have the same shape, and one OPC process may be performed only once for all the pieces of the second pieces of layout 103 that have the same shape.

In FIG. 1, operation S30 may be performed before operation S40, but the order of operations S30 and S40 may not be limited thereto. For example, operations S30 and S40 may be simultaneously performed. In operation S50, the plurality of third pieces of layout 104 may be recombined. Referring to FIG. 2E, a modified design layout 105 may be realized by recombining the plurality of third pieces of layout 104. When the dummy pattern 300 is disposed within the boundary of the plurality of second pieces of layout 103, the plurality of third pieces of layout 104 may be simply repeatedly recombined so as to realize the modified design layout 105. However, when the dummy pattern 300 is disposed on the boundary of the plurality of second pieces of layout 103, the plurality of third pieces of layout 104 may be repeatedly recombined considering the overlapping modified dummy pattern 310 so as to realize the modified design layout 105.

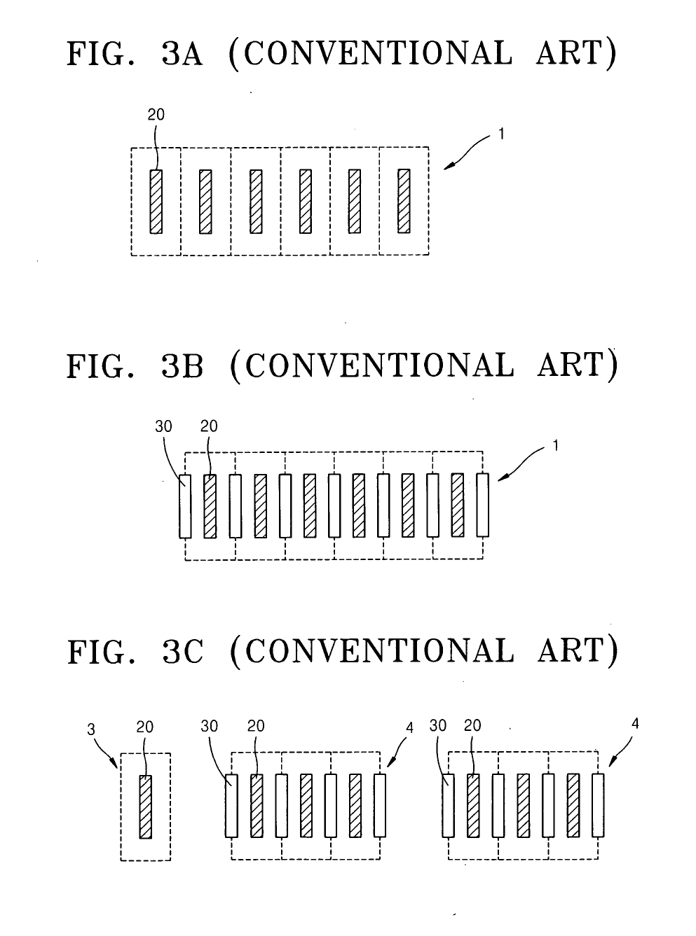

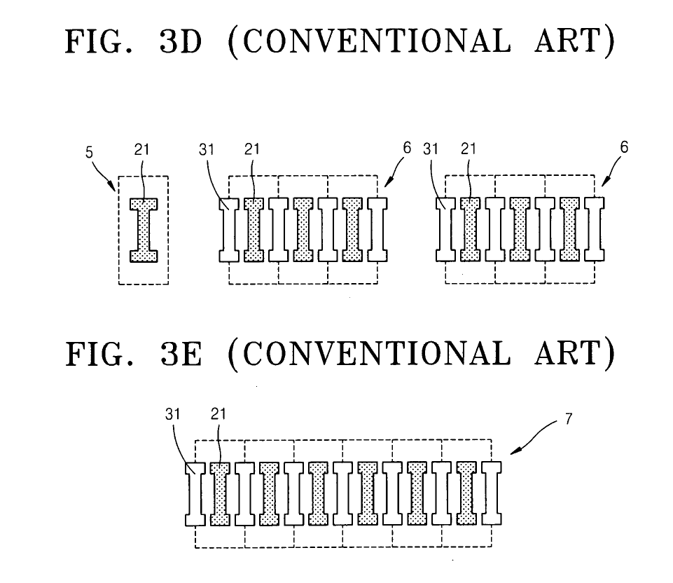

FIGS. 3A through 3E are diagrams sequentially illustrating a method of generating a layout of a semiconductor device, according to a comparative embodiment. Referring to 3A, a design layout 1 including a main pattern 20 may be prepared. The main pattern 20 may include a plurality of unit patterns having the same configuration arranged at uniform intervals. Configuration and location of the main pattern 20 may be in accordance with a hierarchy structure of the design layout 1.

Referring to FIG. 3B, a dummy pattern 30 may be disposed around the main pattern 20, before dividing the design layout 1. The dummy pattern 30 may compensate for proximity effects that may be generated in a non-optical process. For example, the dummy pattern 30 may be an etch-dummy pattern disposed in order to compensate for an etch-loading effect while forming the main pattern 20 via a following etch process. Because the dummy pattern 30 compensates for the proximity effects that may be generated in the non-optical process, the dummy pattern 30 may not be formed having the same configuration and location as those of the main pattern 20 in accordance with the hierarchy structure of the design layout 1.

Referring to FIG. 3C, the design layout 1 may be divided into pluralities of first and second pieces layout 3 and 4 in order to perform OPC calculations using a plurality of calculating machines. Because the first piece of layout 3 may be only formed of the main pattern 20, the first piece of layout 3 may be in accordance with a hierarchy structure including the configuration data and location data of the main pattern 20.

The second piece of layout 4 includes the main pattern 20 and the dummy pattern 30. Because the dummy pattern 30 may not be formed in accordance with the hierarchy structure including the configuration data and location data of the main pattern 20 of the design layout 1, the second piece of layout 4 may be generated in addition to the first piece of layout 3.

Referring to FIG. 3D, an OPC process may be performed for each of the pluralities of first and second pieces of layout 3 and 4, thereby generating modified first pieces of layout 5 and modified second pieces of layout 6. In other words, the OPC process may be performed twice, once for the plurality of first pieces of layout 3 and once for the plurality of second pieces of layout 4. Accordingly, time for performing the OPC process may increase. A modified main pattern 21 and a changed dummy pattern 31 may be realized by performing the OPC process simultaneously on the main pattern 20 and the dummy pattern 30. Referring to FIG. 3E, a changed design layout 7 may be realized by recombining the modified first pieces of layout 5 and the changed second pieces of layout 6. Comparing FIGS. 2A through 2E with FIGS. 3A through 3E, the layout of FIGS. 2A and 2E may be respectively the same as FIGS. 3A and 3E.

However, in FIGS. 2A through 2E, the dummy pattern 300 may be disposed after dividing the design layout 101, and only one OPC process may be performed, thereby excluding repeatedly performing the OPC process for main pattern 200. However, in FIGS. 3A through 3E, the dummy pattern 30 may be disposed before dividing the design layout 1, and a plurality of OPC processes may be performed on the first and second pieces of layout 3 and 4 of the design layout 1. Accordingly, the OPC process may be repeatedly performed on the main pattern 20.

Such a difference may be because a dummy pattern may not be formed in accordance with a hierarchy structure of a main pattern. Accordingly, a time for performing an OPC process may be reduced based on whether the dummy pattern has been disposed before or after dividing a design layout. A computer readable recording medium having recorded thereon a program for executing a method of generating layout of a semiconductor device, according to example embodiments of inventive concepts will now be described.

Functions of software of a computer system performing programming, wherein the software includes an executable code, may be used to realize a method of generating layout of a semiconductor device. Because the method may be identical to the method according to example embodiments of inventive concepts, the details thereof will be omitted. A software code may be executable by a general-purpose computer. During an operation, the software code and related data may be stored in a platform of the general-purpose computer. Alternatively, the software may be stored in another space and/or moved to be loaded to a suitable general-purpose computer system. Accordingly, example embodiments of inventive concepts include at least one software product of a code transmitted by at-least one apparatus-readable medium.

The code may be executed by a processor of the computer system, via the method described in example embodiments of inventive concepts, so that the platform realizes catalogue and/or software downloading functions. The term “computer or apparatus readable medium” denotes a medium that participates in providing commands to a processor for execution. Examples of such a medium include a non-volatile medium, a volatile medium, and a transmission medium, but the medium may be not limited thereto. A non-volatile medium includes an optical or magnetic disk, e.g., a memory in a computer(s) operating as one of the server platforms. A volatile medium includes a dynamic memory, e.g., a main memory of the platform.

A physical transmission medium includes a fiber bundle, a copper wire, or a coaxial cable, which includes a wire including a bus in a computer system. A carrier-wave transmission medium may have an elastic wave or light wave form, which may be generated during an electric signal or electromagnetic signal, or wireless radio frequency (RF) or infrared ray (IR) data communication. Accordingly, examples of the computer-readable medium include a floppy disk, a flexible disk, a hard disk, a magnetic tape, other magnetic media, a CD-ROM, a DVD, and other optical media.

Although not common, examples of the computer-readable medium also include a punch card, a paper tape, other physical media having a pattern of holes, a RAM, a PRAM, a EPROM, a flash-EPROM, other memory chips or cartridges, carrier-wave transmission data or command, a cable or link transmitting a carrier-wave, and other computer-readable media for reading a programming code and/or data. Such examples of the computer-readable medium may be used to transmit at least one sequence of at least one command to a processor for execution.

While inventive concepts have been particularly shown and described with reference to example embodiments thereof, it will be understood that various changes in form and details may be made therein without departing from the spirit and scope of the following claims.

What is claimed is:

1. A method of generating a layout of a semiconductor device, the method comprising:
preparing a design layout including a main pattern;
dividing the design layout into a plurality of first pieces of layout;
preparing a plurality of second pieces of layout by providing a dummy pattern on each of the plurality of first pieces of layout;
preparing a plurality of third pieces of layout by performing an optical proximity correction (OPC) process with respect to each of the plurality of second pieces of layout; and
recombining the plurality of third pieces of layout.

2. The method of claim 1, wherein the dummy pattern is generated around a main pattern so as to uniformly maintain a space and density around the main pattern.

3. The method of claim 1, wherein a configuration and location of the main pattern is in accordance with a hierarchy structure of the design layout, and the plurality of first pieces of layout are in accordance with the hierarchy structure of the design layout.

4. The method of claim 3, wherein the dummy pattern is not in accordance with the hierarchy structure of the design layout.

5. The method of claim 1, wherein preparing the plurality of third pieces of layout further comprises:
performing the OPC process simultaneously on the main pattern and the dummy pattern.

6. The method of claim 1, wherein preparing the plurality of third pieces of layout further comprises:
performing the same OPC process only once for each piece of the plurality of second pieces of layout that have the same shape.

7. The method of claim 1, wherein the dummy pattern is provided on a boundary of the plurality of first pieces of layout.

8. The method of claim 1, wherein preparing the plurality of third pieces of layout further comprises:
forming a modified main pattern and a changed dummy pattern by performing the OPC process simultaneously on the main pattern and the dummy pattern.

9. The method of claim 1, wherein the plurality of second pieces of layout and the plurality of third pieces of layout are prepared simultaneously.

10. The method of claim 1, wherein the plurality of second pieces of layout are prepared before the plurality of third pieces of layout.

11. A computer readable recording medium having recorded thereon a program for executing the method of claim 1.

12. The computer readable recording medium of claim 11, wherein a configuration and location of the main pattern is in accordance with a hierarchy structure of the design layout, and the plurality of first pieces of layout are in accordance with the hierarchy structure of the design layout.

13. The computer readable recording medium of claim 11, wherein the dummy pattern is not in accordance with the hierarchy structure of the design layout.

14. The computer readable recording medium of claim 11, wherein preparing the plurality of third pieces of layout further comprises:
performing the OPC process simultaneously on the main pattern and the dummy pattern.

15. The computer readable recording medium of claim 11, wherein preparing the plurality of third pieces of layout further comprises:
performing the same OPC process only once for each piece of the plurality of second pieces of layout that have the same shape.

16. The computer readable recording medium of claim 11, wherein the dummy pattern is generated around a main pattern so as to uniformly maintain a space and density around the main pattern.

17. The computer readable recording medium of claim 11, wherein the dummy pattern is provided on a boundary of the plurality of first pieces of layout.

18. The computer readable recording medium of claim 11, wherein preparing the plurality of third pieces of layout further comprises:
forming a modified main pattern and a changed dummy pattern by performing the OPC process simultaneously on the main pattern and the dummy pattern.

19. The computer readable recording medium of claim 11, wherein the plurality of second pieces of layout and the plurality of third pieces of layout are prepared simultaneously.

20. The computer readable recording medium of claim 11, wherein the plurality of second pieces of layout are prepared before the plurality of third pieces of layout.
